(19) United States
(12) Patent Application Publication
(10) Pub. No.: US 2026/0285413 A1
(43) Pub. Date: Sep. 24, 2026

(54) INSTRUMENT PANEL REINFORCEMENT

(71) Applicant: FUTABA INDUSTRIAL CO., LTD., Okazaki-shi (JP)

(72) Inventors: Hirotaka Niinomi, Okazaki-shi (JP); Fumiki Nagae, Okazaki-shi (JP); Shun Inagaki, Okazaki-shi (JP)

(21) Appl. No.: 19/433,296

(22) Filed: Dec. 26, 2025

(30) Foreign Application Priority Data
Jan. 28, 2025 (JP) 2025-012211

(51) Int. Cl. B62D 25/14; B62D 1/16

(52) U.S. Cl. CPC B62D 25/145; B62D 1/16

(57) ABSTRACT

A steering bracket of an instrument panel reinforcement includes an upper member and a lower member. The upper member includes an upper top portion and an upper first side wall and an upper second side wall facing each other in vehicle-width directions. The lower member includes a lower top portion joined to the upper top portion and a lower first side wall and a lower second side wall facing each other in the vehicle-width directions. The lower first side wall is joined to an outer-circumferential surface of the first member, and joined to upper first side wall overlapping the lower first side wall from a driver side. The lower second side wall is joined to an outer-circumferential surface of the second member, and joined to the upper second side wall overlapping the lower second side wall from a passenger side.

### CROSS-REFERENCE TO RELATED APPLICATIONS

This application claims the benefit of Japanese Patent Application No. 2025-012211 filed on Jan. 28, 2025 with the Japan Patent Office, the entire disclosure of which is incorporated herein by reference.

### BACKGROUND

The present disclosure relates to an instrument panel reinforcement.

An instrument panel reinforcement disclosed in Japanese Unexamined Patent Application Publication No. 2011-88471 is divided into a driver-side portion located in front of a driver's seat and a passenger-side portion located in front of a passenger seat. These portions are joined by a receiving portion that is provided in a steering column and that has a U-shape in cross section.

### SUMMARY

However, in the instrument panel reinforcement of Japanese Unexamined Patent Application Publication No. 2011-88471, the stiffness of the receiving portion that joins the driver-side portion and the passenger-side portion may be insufficient. This may cause deformation of the receiving portion, generation of vibration in a steering, or delays in reflection of steering operation in vehicle behavior.

It is desirable that one aspect of the present disclosure improves stiffness of a steering bracket that joins a driver-side portion and a passenger-side portion of an instrument panel reinforcement.

One aspect of the present disclosure is an instrument panel reinforcement that is configured to be mounted in a vehicle and support a steering column and that comprises a first member, a second member, and a steering bracket. The first member is arranged on a driver side of the vehicle and extends in vehicle-width directions. The second member is arranged on a passenger side of the vehicle and extends in the vehicle-width directions. The steering bracket is located between the first member and the second member and includes an upper member and a lower member. The upper member includes an upper top portion, an upper first side wall, and an upper second side wall. The upper top portion is a plate-shaped portion. The upper first side wall and the upper second side wall are plate-shaped portions protruding downward from the upper top portion and facing each other in the vehicle-width directions. The lower member includes a lower top portion, a lower first side wall, a lower second side wall, a lower first-member joint portion, and a lower second-member joint portion. The lower top portion is a plate-shaped portion arranged such that the upper top portion overlaps the lower top portion from above and joined to the upper top portion. The lower first side wall and the lower second side wall are plate-shaped portions protruding downward from the lower top portion and facing each other in the vehicle-width directions. The lower first-member joint portion is provided on the lower first side wall and configured to be joined to an outer-circumferential surface of the first member. The lower second-member joint portion is provided on the lower second side wall and configured to be joined to an outer-circumferential surface of the second member. The upper top portion and the lower top portion are provided with a rear column joint portion configured to join the steering column thereto. The lower first side wall is arranged such that the upper first side wall overlaps the lower first side wall from the driver side and joined to the upper first side wall. The lower second side wall is arranged such that the upper second side wall overlaps the lower second side wall from the passenger side and joined to the upper second side wall.

With the above-described configuration, the upper top portion, the upper first side wall, and the upper second side wall of the upper member are respectively joined to the lower top portion, the lower first side wall, and the lower second side wall of the lower member in an overlapping state. The lower first-member joint portion of the lower first side wall and the lower second-member joint portion of the lower second side wall are respectively joined to the first member and the second member. Accordingly, the stiffness of the steering bracket that joins a driver-side portion of the instrument panel reinforcement and a passenger-side portion of the instrument panel reinforcement is improved.

In one aspect of the present disclosure, the rear column joint portion may be configured as at least one bolt hole passing through the upper top portion and the lower top portion.

With the above-described configuration, the upper top portion and the lower top portion can be suitably joined to the steering column.

In one aspect of the present disclosure, the lower first-member joint portion may be formed to extend, along the outer-circumferential surface of the first member, over a range of 90 degrees or more in a circumferential direction about a central axis of the first member. The lower second-member joint portion may be formed to extend, along the outer-circumferential surface of the second member, over a range of 90 degrees or more in a circumferential direction about a central axis of the second member.

With the above-described configuration, the lower first-member joint portion and the lower second-member joint portion can be respectively joined to the first member and the second member more firmly. Accordingly, the stiffness of the instrument panel reinforcement is improved.

In one aspect of the present disclosure, the steering bracket may further include a front member located below the upper member and forward of the lower member. The front member may include a front bottom portion, a front body joint portion, a front first side wall, and a front second side wall. The front bottom portion may be a plate-shaped portion. The front body joint portion is configured to be joined, forward of the first and second members, to a vehicle body. The front first side wall and the front second side wall may be plate-shaped portions protruding upward from the front bottom portion and facing each other in the vehicle-width directions. The front first side wall and the front second side wall may be provided with a front column joint portion configured to join the steering column thereto.

With the above-described configuration, the steering column can be suitably supported by the front column joint portion.

In one aspect of the present disclosure, the upper top portion may include a first portion located above the lower top portion and a second portion located above the front member. The second portion may be an elongated portion extending forward from the first portion, and a length of the second portion in the vehicle-width directions may be shorter than that of the first portion.

With the above-described configuration, the steering bracket can be lightweighted.

In one aspect of the present disclosure, a space may be provided between the front member and the lower member. The front column joint portion may be configured as two bolt holes each provided near rear ends of the front first side wall and the front second side wall.

With the above-described configuration, the steering column can be suitably supported by the front column joint portion.

One aspect of the present disclosure may further comprise a third member that is an elongated member configured to be joined, below the instrument panel reinforcement, to a vehicle body. The steering bracket may further include a lateral member joined to the lower second side wall and to the outer-circumferential surface of the second member. An end of the third member may be joined to the lateral member.

With the above-described configuration, the stiffness of the steering bracket is further improved.

In one aspect of the present disclosure, the lateral member may include a floor-to-brace joint portion and a bracket joint portion. The floor-to-brace joint portion may be joined to the end of the third member. The bracket joint portion may be joined to the upper member. The floor-to-brace joint portion may include a main surface portion, a first side wall, and an outer-circumferential surface joint portion. The main surface portion may be arranged so as to face the second member with a space therebetween and joined to the end of the third member. The first side wall may protrude toward the second member from an edge of the main surface portion. The outer-circumferential surface joint portion may be provided at an edge portion of the first side wall and joined to the second member.

With the above-described configuration, the lateral member and the third member can be suitably joined.

In one aspect of the present disclosure, the third member may include a body that is a tubular portion and an upper-end joint portion provided at an upper end of the body. The upper-end joint portion may include a base and a second side wall. The base may be an elongated plate-shaped portion. The base may be joined to the lateral member. The second side wall may be a wall-shaped portion protruding from an edge of the base toward a side opposite where the lateral member is located.

With the above-described configuration, the lateral member and the third member can be suitably joined.

### BRIEF DESCRIPTION OF THE DRAWINGS

An example embodiment of the present disclosure will be described hereinafter with reference to the accompanying drawings, in which:

FIG. 1A is a front perspective view of an instrument panel reinforcement (hereinafter, referred to as an “instrument panel R/F”);

FIG. 1B is a rear perspective view of the instrument panel R/F;

FIG. 2A is a rear perspective view of a steering bracket and so on as seen from a driver's seat;

FIG. 2B is a front perspective view of the steering bracket and so on as seen from the driver's seat;

FIG. 3 is a rear perspective view of the steering bracket and so on as seen from a passenger seat;

FIG. 4 is a front perspective view of the steering bracket and so on as seen from the passenger seat;

FIG. 5 is a side view of the steering bracket and so on as seen from a driver side;

FIG. 6 is a side view of the steering bracket and so on as seen from a passenger side;

FIG. 7 is a top view of the steering bracket and so on; and

FIG. 8 is a bottom view of the steering bracket and so on.

### DETAILED DESCRIPTION OF EXEMPLARY EMBODIMENTS

### 1. Overview

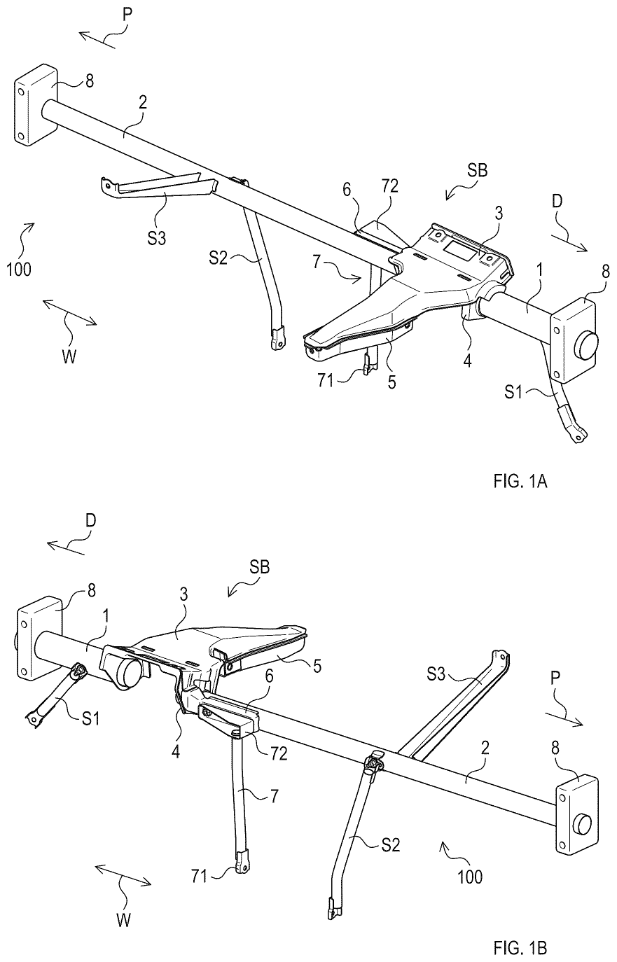

An instrument panel R/F 100 is configured to be mounted inside a dashboard of a vehicle and support a device such as a steering column SC and the like (see FIGS. 1A and 1B). The instrument panel R/F 100 is made of iron, as an example, but not limited to, a material such as aluminum or magnesium, for example. The instrument panel R/F 100 comprises a first member 1, a second member 2, a steering bracket SB, a floor-to-brace (i.e., third member) 7, two lateral-end joint portions 8, a first reinforcement member S1, a second reinforcement member S2, and a third reinforcement member S3.

### 2. First and Second Members

The first and second members 1 and 2 are elongated members extending straight in vehicle-width directions W. As an example, the first and second members 1 and 2 are cylindrical, and a diameter of each of the first and second members 1 and 2 in a cross section perpendicular to the vehicle-width directions W (hereafter, simply referred to as a “cross section”) is constant (see FIGS. 1A and 1B). However, the present disclosure is not limited thereto and, for example, each of the first and second members 1 and 2 may have a portion with a reduced diameter, or may be a tubular member having an oval or substantially polygonal cross section. An outer-circumferential surface of each of the first and second members 1 and 2 may be provided with a flat portion to which a device is attachable.

The first member 1 is located in front of a driver's seat, and an end portion of the first member 1 on a driver side D is provided with a lateral-end joint portion 8 configured to be joined to a pillar of a vehicle body. The second member 2 is located in front of a passenger seat, an end portion of the second member 2 on a passenger side P is provided with a lateral-end joint portion 8 configured to be joined to a pillar in the vehicle body.

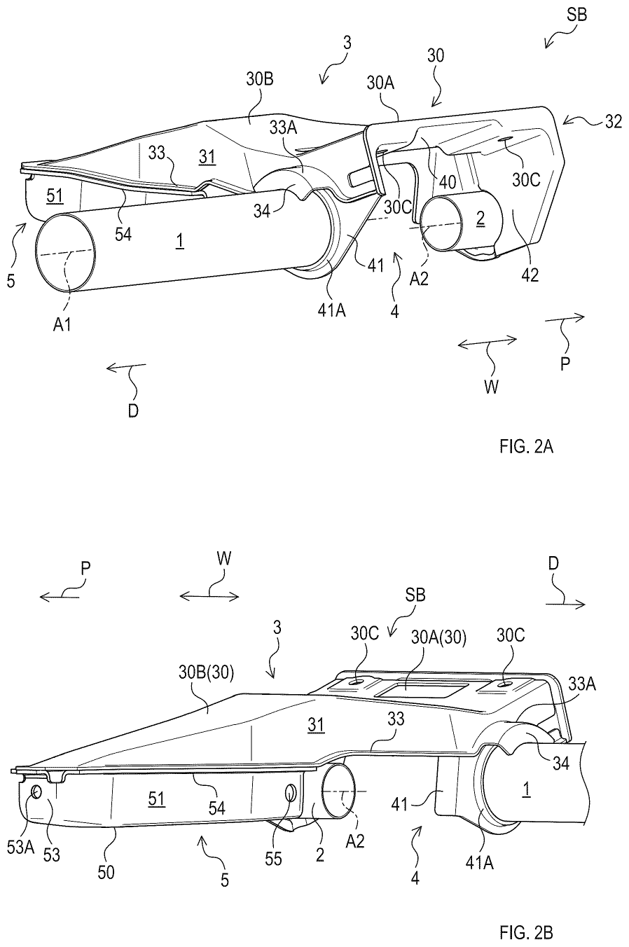

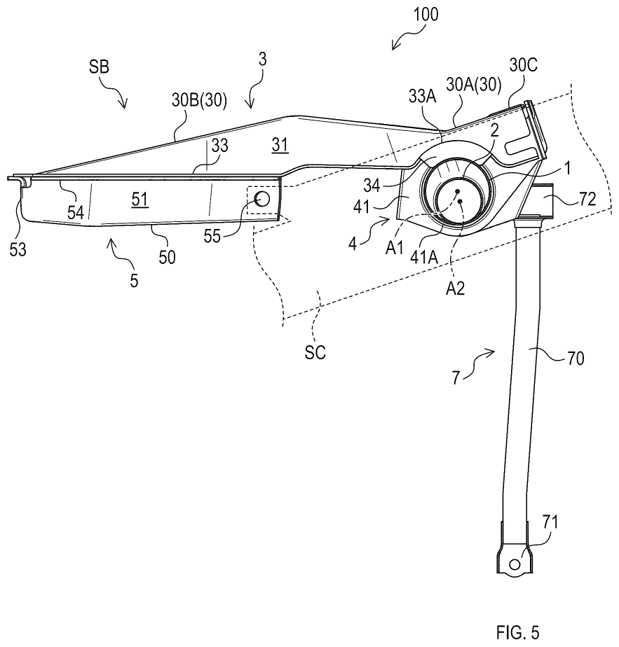

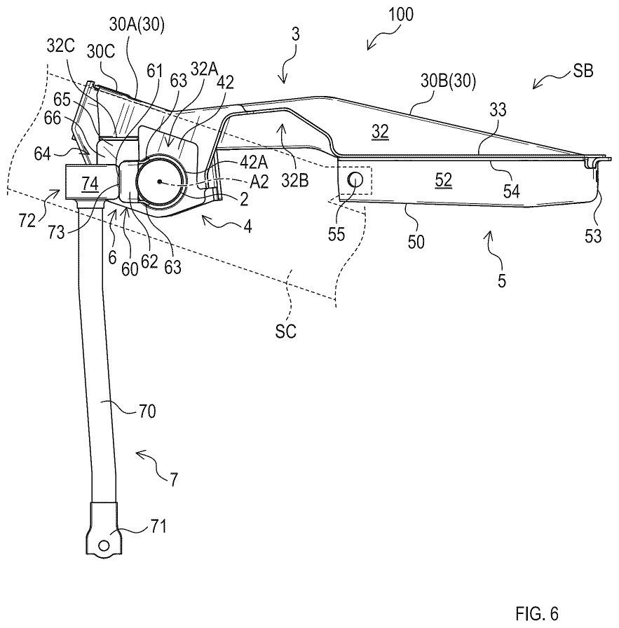

An end portion of the first member 1 on the passenger side P and an end portion of the second member 2 on the driver side D are spaced from each other, and these end portions are joined to the steering bracket SB (see FIGS. 2A to 4). The steering column SC is arranged below the steering bracket SB, and the steering column SC is located between the end portion of the first member 1 on the passenger side P and the end portion of the second member 2 on the driver side D (see FIGS. 5 and 6).

The first and second members 1 and 2 are arranged to overlap in the vehicle-width directions W. However, the present disclosure is not limited thereto, and the first and second members 1 and 2 may be arranged to be shifted from each other in up-down directions and/or front-rear directions, for example. The cross-sectional diameter of the first member 1 is smaller than the cross-sectional diameter of the second member 2. However, the present disclosure is not limited thereto, and these cross-sectional diameters may be determined as appropriate.

### 3. Steering Bracket

The steering bracket SB is a plate-shaped member, supports the steering column SC from above, and is joined to the end portion of the first member 1 on the passenger side P and to the end portion of the second member 2 on the driver side D (see FIGS. 2A to 8). The steering bracket SB comprises an upper member 3, a lower member 4, a front member 5, and a lateral member 6.

### (1) Upper Member

The upper member 3 is a plate-shaped member and comprises an upper top portion 30, an upper first side wall 31, an upper second side wall 32, an upper edge portion 33, and an upper first-member joint portion 34 (see FIGS. 2A to 8).

### (1-1) Upper Top Portion

The upper top portion 30 comprises a first portion 30A, a second portion 30B, and a rear column joint portion 30C (described in detail below) (see FIGS. 2A to 8).

The first portion 30A is a substantially rectangular portion and is arranged above the first and second members 1 and 2 such that a longitudinal direction of the first portion 30A coincides with the vehicle-width directions W.

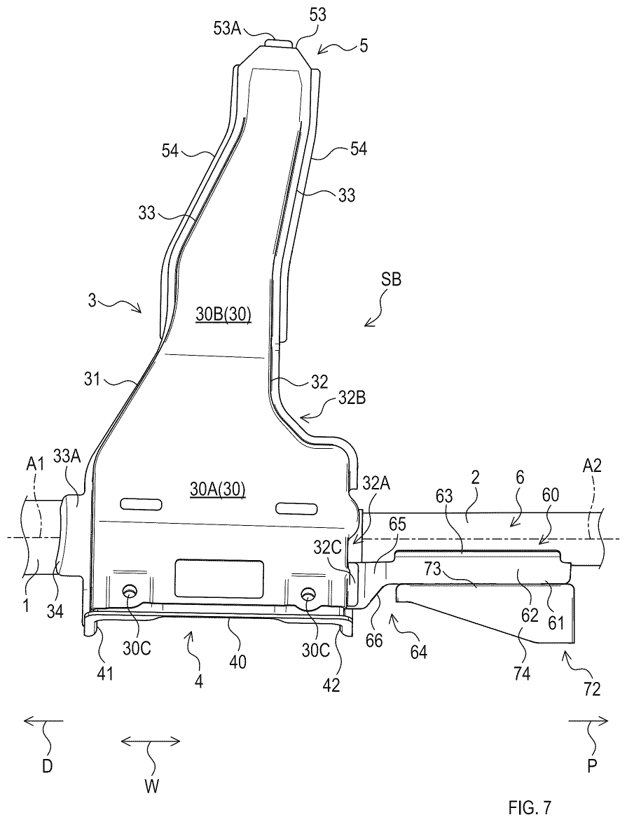

The second portion 30B is a roughly triangular portion extending forward from a front end of the first portion 30A, and the width of the second portion 30B decreases toward the front (see FIG. 7). A front portion of the second portion 30B is inclined downward toward the front. A length of the second portion 30B in the vehicle-width directions W is shorter than that of the first portion 30A.

### (1-2) Upper First Side Wall

The upper first side wall 31 is a wall-shaped portion protruding downward from ends, on the driver side D, of the first and second portions 30A and 30B of the upper top portion 30 (see FIGS. 2A, 2B, and 5). The upper first side wall 31 faces the upper second side wall 32 in the vehicle-width directions W.

### (1-3) Upper Second Side Wall

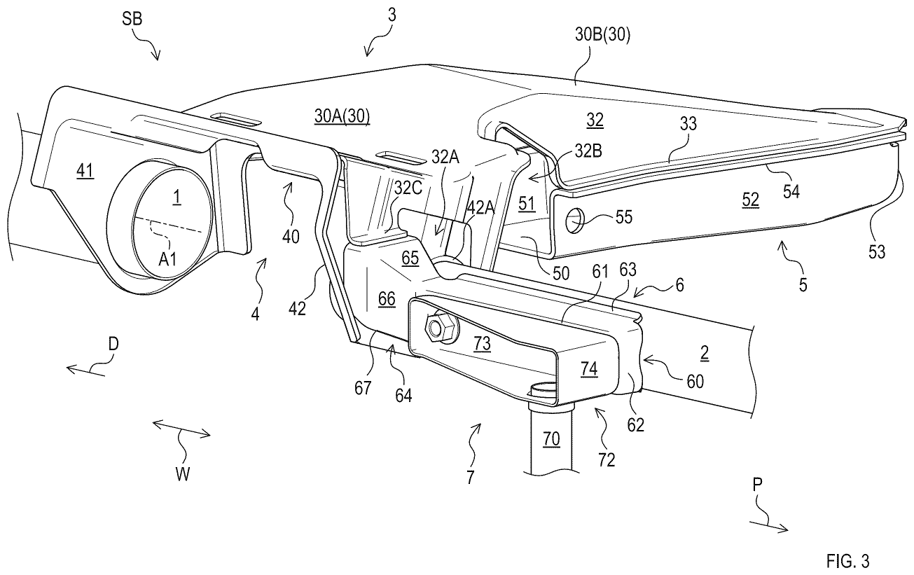

The upper second side wall 32 is a wall-shaped portion protruding downward from ends, on the passenger side P, of the first and second portions 30A and 30B of the upper top portion 30 (see FIGS. 3, 4, and 6).

A first cutout part 32A is formed near a rear end of the upper second side wall 32, and the second member 2 is arranged at the first cutout part 32A. Forward of the first cutout part 32A in the upper second side wall 32, a second cutout part 32B is formed.

### (1-4) Upper Edge Portion

The upper edge portion 33 is a flange-shaped portion extending along a lower end of the upper member 3 (see FIGS. 2A to 8).

The upper edge portion 33 is provided entirely along a lower end of the upper first side wall 31. The upper edge portion 33 is also provided in a portion of a lower end of the upper second side wall 32 other than the first cutout part 32A. The upper edge portion 33 is also provided at a front end of the upper top portion 30.

The upper edge portion 33 includes a wider part 33A near the first member 1. The wider part 33A is curved along the outer-circumferential surface of the first member 1 and is wider relative to the rest of the upper edge portion 33. The wider part 33A is located above the end portion of the first member 1 on the passenger side P, and a space is formed between the wider part 33A and the first member 1.

### (1-5) Upper First-Member Joint Portion

An end of the wider part 33A on a side opposite where the upper first side wall 31 is located is provided with an upper first-member joint portion 34 that is a wall-shaped portion protruding downward and is joined to the first member 1 (see FIGS. 2A, 2B, 5, and 7). A lower end of the upper first-member joint portion 34 has a curved shape extending along the outer-circumferential surface of the first member 1 and is welded to this outer-circumferential surface.

### (2) Lower Member

The lower member 4 is a plate-shaped member and comprises a lower top portion 40, a lower first side wall 41, and a lower second side wall 42 (see FIGS. 2A to 8).

### (2-1) Lower Top Portion

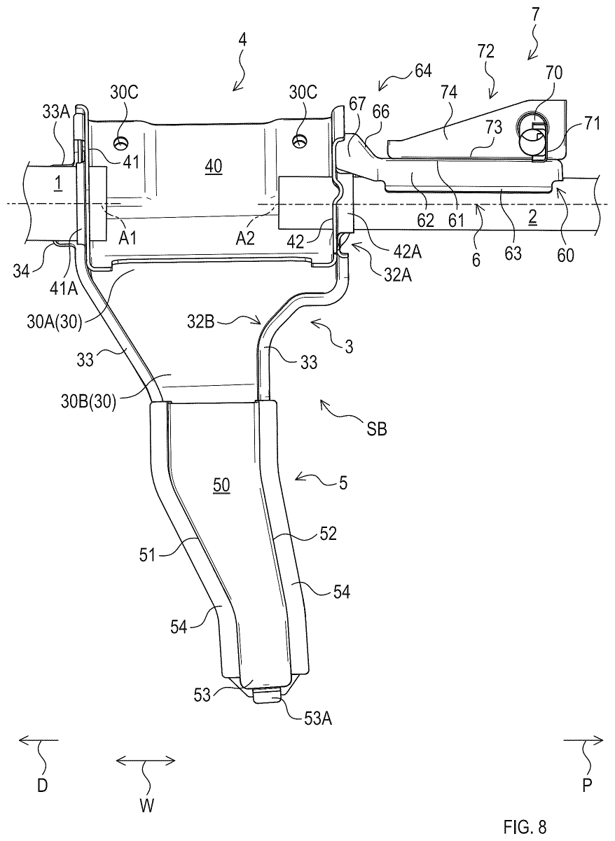

The lower top portion 40 is a substantially rectangular portion and is arranged above the first and second members 1 and 2 such that a longitudinal direction of the lower top portion 40 coincides with the vehicle-width directions W (see FIGS. 2A and 8).

### (2-2) Lower First Side Wall

The lower first side wall 41 is a wall-shaped portion protruding downward from an end of the lower top portion 40 on the driver side D (see FIGS. 2A to 3, 5, and 8). The lower first side wall 41 faces the lower second side wall 42 in the vehicle-width directions W.

The lower first side wall 41 is joined to the end portion of the first member 1 on the passenger side P. Specifically, the lower first side wall 41 includes a first hole into which the first member 1 is inserted, and an edge of the first hole is provided with a lower first-member joint portion 41A that is a wall-shaped portion surrounding the first hole and protruding toward the driver side D. The lower first-member joint portion 41A extends along the outer-circumferential surface of the end portion of the first member 1 and is welded to this outer-circumferential surface.

### (2-3) Lower Second Side Wall

The lower second side wall 42 is a wall-shaped portion protruding downward from an end of the lower top portion 40 on the passenger side P (see FIGS. 2A, 3, 4, 6, and 8).

The lower second side wall 42 is joined to the end portion of the second member 2 on the driver side D. Specifically, the lower second side wall 42 includes a second hole into which the second member 2 is inserted, and an edge of the second hole is provided with a lower second-member joint portion 42A that is a wall-shaped portion surrounding the second hole and protruding toward the passenger side P. The lower second-member joint portion 42A extends along the outer-circumferential surface of the end portion of the second member 2 and is welded to this outer-circumferential surface.

### (2-4) Modified Examples

The lower first-member joint portion 41A may protrude from the edge of the first hole toward the passenger side P. The lower second-member joint portion 42A may protrude from the edge of the second hole toward the driver side D. Each of the lower first-member joint portion 41A and the lower second-member joint portion 42A may be an arc-shaped portion extending along the edge of the first hole or the second hole.

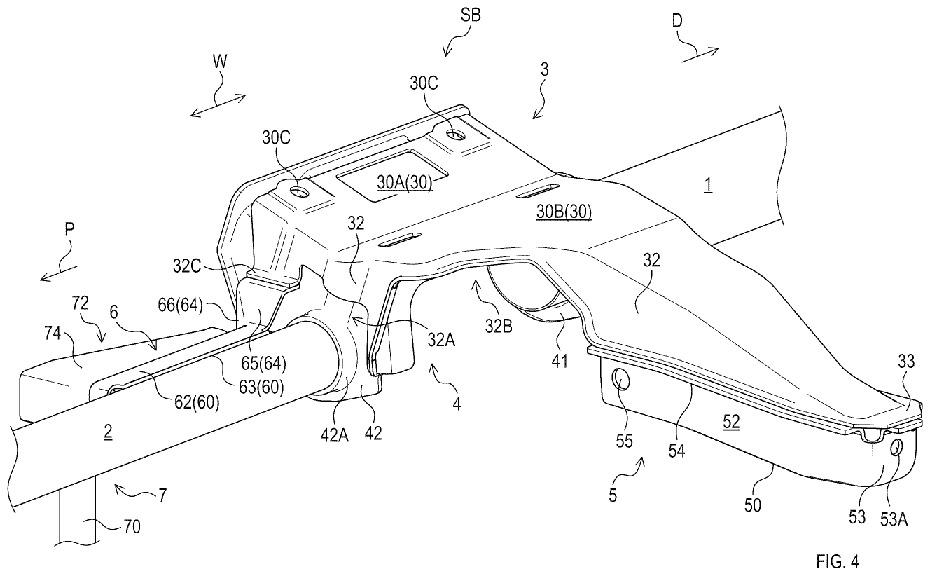

In this case, preferably, the lower first-member joint portion 41A is located above and extends over a range of 90 degrees or more in a circumferential direction about a central axis A1 of the first member 1 (see FIGS. 2A, 2B, 5, and 8). In addition, preferably, the lower second-member joint portion 42A is located above and extends over a range of 90 degrees or more in a circumferential direction about a central axis A2 of the second member 2 (see FIGS. 4, 6, and 8). The central axes A1 and A2 are virtual straight lines passing through the respective centers of the cross sections of the first and second members 1 and 2 and extending in the vehicle-width directions W.

Furthermore, part of a lower end of the lower first side wall 41 may be formed into an arc-shape, and a wall-shaped lower first-member joint portion may be formed along the arc-shaped part and welded to the outer-circumferential surface of the first member 1. Similarly, part of a lower end of the lower second side wall 42 may be formed into an arc-shape, and a wall-shaped lower second-member joint portion may be formed along the arc-shaped part and welded to the outer-circumferential surface of the second member 2.

Also in this case, preferably, the lower first-member joint portion 41A extends over the range of 90 degrees or more in the circumferential direction about the central axis A1 of the first member 1. In addition, preferably, the lower second-member joint portion 42A extends over the range of 90 degrees or more in the circumferential direction about the central axis A2 of the second member 2.

### (3) Joining Upper Member and Lower Member

The upper member 3 is arranged so as to overlap the lower member 4 from above and joined to the lower member 4 (see FIGS. 2A to 6, and 8).

Specifically, the upper top portion 30 is arranged so as to overlap the lower top portion 40 in a state in which the upper top portion 30 is in contact with an upper surface of the lower top portion 40, and then is welded to the lower top portion 40. The upper first side wall 31 is arranged so as to overlap the lower first side wall 41 in a state in which the upper first side wall 31 is in contact with the driver side D of the lower first side wall 41, and then is welded to the lower first side wall 41. The upper second side wall 32 is arranged so as to overlap the lower second side wall 42 in a state in which the upper second side wall 32 is in contact with the passenger side P of the lower second side wall 42, and then is welded to the lower second side wall 42.

### (3-1) Rear Column Joint Portion

The rear column joint portion 30C for joining the steering column SC is provided near rear ends of the upper top portion 30 and the lower top portion 40 overlapping with each other (see FIGS. 2B and 4 to 8).

As an example, the steering bracket SB and the steering column SC are fastened with a bolt. The rear column joint portion 30C is configured as bolt holes (as an example, two bolt holes) that each pass through the upper top portion 30 and the lower top portion 40 and that are arranged side by side along the rear ends thereof (in other words, along the vehicle-width directions W), as an example.

### (4) Front Member

The front member 5 is a plate-shaped member and comprises a front bottom portion 50, a front first side wall 51, a front second side wall 52, a front end wall 53, a front edge portion 54, and a front column joint portion 55 (see FIGS. 2A to 8). The front member 5 is located below the upper member 3 (more specifically, the second portion 30B), arranged forward of the lower member 4, and spaced from the lower member 4.

### (4-1) Front Bottom Portion

The front bottom portion 50 is an elongated portion extending in front-rear directions and extending from a front side of the second cutout part 32B of the upper member 3 to the vicinity of a front end of the upper member 3 (see FIGS. 2B to 6, and 8). The front bottom portion 50 faces, in up-down directions, a part of the upper member 3 that includes a front end of the second portion 30B of the upper top portion 30.

### (4-2) Front First Side Wall and Front Second Side Wall

The front first side wall 51 and the front second side wall 52 are wall-shaped portions that respectively protrude upward from an end of the front bottom portion 50 on the driver side D and from an end of the front bottom portion 50 on the passenger side P and extends from a rear end of the front bottom portion 50 to a front end of the front bottom portion 50 (see FIGS. 2A to 6, and 8). The front first side wall 51 and the front second side wall 52 face each other in the vehicle-width directions W.

The front first side wall 51 and the front second side wall 52 are respectively aligned, in the up-down directions, with the upper first side wall 31 and the upper second side wall 32 at a portion of the upper member 3 that includes the front end of the second portion 30B.

### (4-3) Front Column Joint Portion

The front column joint portion 55 for joining the steering column SC is provided near rear ends of the front first side wall 51 and the front second side wall 52 (see FIGS. 2B to 6). As an example, similarly to the rear column joint portion 30C, the front column joint portion 55 is configured as two bolt holes that each pass through a corresponding one of the front first side wall 51 and the front second side wall 52, and the steering column SC is to be fastened with bolts that are to pass through the respective bolt holes.

### (4-4) Front End Wall

The front end wall 53 is a wall-shaped portion protruding upward from the front end of the front bottom portion 50 (see FIGS. 2B and 4 to 8). Both ends of the front end wall 53 in the vehicle-width directions W are respectively continuous to the front first side wall 51 and the front second side wall 52.

The front end wall 53 includes a front body joint portion 53A to be joined to the vehicle body, forward of the first and second members 1 and 2, in other words, forward of the steering column SC. As an example, the front body joint portion 53A is formed as a bolt hole used for fastening to the vehicle body.

### (4-5) Front Edge Portion

The front edge portion 54 is a flange-shaped portion extending along upper ends of the front first side wall 51, the front second side wall 52, and the front end wall 53 (see FIGS. 2B to 8). The front member 5 is arranged below the upper member 3 so as to face the portion of the upper member 3 that includes the front end of the second portion 30B of the upper top portion 30. The front edge portion 54 is in contact with the upper edge portion 33 of the second portion 30B of the upper member 3, and the front edge portion 54 and the upper edge portion 33 are welded to each other.

### (5) Lateral Member

The lateral member 6 is a plate-shaped member arranged on sides, on the passenger side P, of the upper second side wall 32 and the lower second side wall 42 and comprises a floor-to-brace joint portion 60 and a bracket joint portion 64 (see FIGS. 3, 4, and 6 to 8).

### (5-1) Floor-to-Brace Joint Portion

The floor-to-brace joint portion 60 is a plate-shaped member and is joined to the outer-circumferential surface of the second member 2 and to an upper-end joint portion 72 (details to be described below) located at an upper end of the floor-to-brace 7 (see FIGS. 3, 4, and 6 to 8). The floor-to-brace joint portion 60 comprises a main surface portion 61, a first side wall 62, and an outer-circumferential surface joint portion 63.

The main surface portion 61 is an elongated rectangular portion extending in the vehicle-width directions W and is arranged so as to face the outer-circumferential surface of the second member 2 with a space therebetween. The main surface portion 61 is configured such that the upper-end joint portion 72 of the upper end of the floor-to-brace 7 is joined thereto, and the main surface portion 61 is provided with two bolt holes for fastening to the upper-end joint portion 72, as an example.

A portion that forms an upper edge, a lower edge, and a passenger side P edge of the main surface portion 61 is provided with the first side wall 62 protruding toward the second member 2. Ends of upper and lower portions of the first side wall 62 on a side opposite where the main surface portion 61 is located are provided with respective outer-circumferential surface joint portions 63 extending in the vehicle-width directions W. Each of the outer-circumferential surface joint portions 63 has a shape corresponding to the outer-circumferential surface of the second member 2, and is welded to this outer-circumferential surface.

### (5-2) Bracket Joint Portion

The bracket joint portion 64 is a plate-shaped member and is joined to a portion of the lower second side wall 42 between the lower second-member joint portion 42A and a rear end of the lower second side wall 42 (more specifically, a portion of the lower second side wall 42 near the lower second-member joint portion 42A) (FIGS. 3, 4, and 6 to 8). The bracket joint portion 64 is joined to an upper second joint portion 32C that is a flange-shaped portion protruding from the lower end of the upper second side wall 32 to the driver side D. The bracket joint portion 64 comprises an upper surface portion 65, a side surface portion 66, and a lower surface portion 67.

The side surface portion 66 extends so as to face the outer-circumferential surface of the second member 2, and extends from the main surface portion 61 of the floor-to-brace joint portion 60 to the lower second side wall 42. The side surface portion 66 is inclined so that a distance from the second member 2 increases as the side surface portion 66 is closer to the lower second side wall 42. The side surface portion 66 may extend along the second member 2 without being inclined relative to the second member 2.

The lower surface portion 67 is a portion protruding from a lower end of the side surface portion 66 to a second member 2 side, and extends from the lower portion of the first side wall 62 of the floor-to-brace joint portion 60 to the lower second side wall 42.

The upper surface portion 65 is a portion protruding from an upper end of the side surface portion 66 to the second member 2 side, and extends from the upper portion of the first side wall 62 of the floor-to-brace joint portion 60 to the lower second side wall 42. The upper surface portion 65 is inclined upward as the upper surface portion 65 is closer to the lower second side wall 42. The upper surface portion 65 may extend along the second member 2 without being inclined upward. To a portion of the upper surface portion 65 adjacent to the lower second side wall 42, the upper second joint portion 32C at the lower end of the upper second side wall 32 is welded.

Respective ends, on a lower second side wall 42 side, of the upper surface portion 65, the side surface portion 66, and the lower surface portion 67 are welded to the lower second side wall 42.

### 4. Floor-to-Brace

The floor-to-brace 7 is a rod-like member for reinforcing the steering column SC (see FIGS. 1A, 1B, and 3 to 8). The floor-to-brace 7 is to be joined to the steering column SC and to a floor member of the vehicle body, below the instrument panel R/F 100, for forming a floor of a vehicle compartment. The floor-to-brace 7 comprises a body 70, a lower-end joint portion 71, and the upper-end joint portion 72.

The body 70 is a tubular member extending in a substantially straight line, and the upper-end joint portion 72 and the lower-end joint portion 71 are respectively provided at upper and lower ends of the body 70.

In the lower-end joint portion 71, a bolt hole for fastening to the floor member is formed.

The upper-end joint portion 72 is a plate-shaped portion configured to be fastened to the lateral member 6 of the steering bracket SB with a bolt, and comprises a base 73 and a second side wall 74.

The base 73 has a substantially rectangular, elongated shape extending in the vehicle-width directions W and is arranged to overlap with the main surface portion 61 of the lateral member 6 of the steering bracket SB. In the base 73, bolt holes for fastening to the main surface portion 61 are formed near both ends of the base 73 in the vehicle-width directions W.

The second side wall 74 is a wall-shaped portion protruding from an edge of the base 73 toward a side opposite where the lateral member 6 is located, and surrounds the base 73. The height by which the second side wall 74 protrudes from the base 73 increases toward the passenger side P.

The floor-to-brace 7 may be configured as a tubular member without the lower-end joint portion 71 and the upper-end joint portion 72. In this case, respective bolt holes may be provided in upper and lower end portions of the floor-to-brace 7, and the floor-to-brace 7 may be fastened to the steering bracket SB and to the floor member through these bolt holes.

### 5. Other Members

The lateral-end joint portions 8 provided at the end portion of the first member 1 on the driver side D and at the end portion of the second member 2 on the passenger side P are box-shaped members each having a substantially rectangular parallelepiped box shape (see FIGS. 1A and 1B). Each of the lateral-end joint portions 8 has a flat shape extending in the up-down directions and front-rear directions and includes a joint portion provided, on front and rear sides of each lateral-end joint portion 8, for joining with the vehicle body. As an example, in the joint portion, two bolt holes aligned in the up-down directions are formed, and each of the lateral-end joint portions 8 is to be fastened to the vehicle body with bolts inserted into the corresponding bolt holes.

The first to third reinforcement members S1 to S3 are rod-like members for supporting the instrument panel R/F 100. A first end of each of the first to third reinforcement members S1 to S3 is joined to the vehicle body, and a second end thereof is joined to the first member 1 or to the second member 2 of the instrument panel R/F 100. As an example, each end of the first to third reinforcement members S1 to S3 may be fastened to the vehicle body or the instrument panel R/F 100 with a bolt.

Specifically, the second end of the first reinforcement member S1 is joined to a rear side of the first member 1 in the substantially center in the vehicle-width directions W, as an example. The second end of the second reinforcement member S2 is joined to a rear side of the second member 2 in the substantially center in the vehicle-width directions W, as an example. The second end of the third reinforcement member S3 is joined to a front side of the second member 2 in the substantially center in the vehicle-width directions W, as an example.

### 6. Arrangement of Steering Column

The steering column SC is fastened to the rear column joint portion 30C in the steering bracket SB and to the front column joint portion 55 in the steering bracket SB with bolts (see FIGS. 5 and 6). At this time, the steering column SC is arranged between the end portion of the first member 1 on the passenger side P and the end portion of the second member 2 on the driver side D. The steering column SC is located below the upper top portion 30 and the lower top portion 40 of the steering bracket SB, and located between the upper and lower first side walls 31 and 41 and the upper and lower second side walls 32 and 42.

### 7. Effects

(1) For vehicles, instrument panels may be required to be lowered in order to increase the driver's front visibility, and in such cases, the instrument panels R/F are provided at low positions. Also for low-floor vehicles, the positions of the instrument panels R/F are low.

However, in order to ensure vehicle maneuverability and to enable a driver of such a vehicle to operate the steering naturally when the driver sits in the driver's seat, the steering column needs to be arranged at or above a certain height. In order to ensure the height of the steering column in the vehicle where the instrument panel R/F is at the lower position, portion of the instrument panel R/F for supporting the steering column is assumed to have a curved shape so as to protrude upward. However, if such a shape is employed, there is a problem that molding of the instrument panel R/F becomes difficult, resulting in increasing development costs and manufacturing costs.

In contrast, the instrument panel R/F 100 of the aforementioned embodiment is configured such that the first member 1 and the second member 2 are joined by the steering bracket SB. In addition, the steering column SC is arranged below the steering bracket SB and between the first member 1 and the second member 2. Therefore, while arranging the first and second members 1 and 2 of the instrument panel R/F 100 at lower positions and ensuring the height of the steering column SC, it is possible to inhibit an increase in the difficulty in the molding of the instrument panel R/F 100, thereby reducing the development costs and the manufacturing costs.

However, in a case in which the instrument panel R/F is composed of the first member on the driver side and the second member on the passenger side that are divided and of the bracket that couples these members and that supports the steering column, load distribution may become difficult. This may cause a decrease in the stiffness against the load generated by steering operation, resulting in generation of vibration in the steering or a delay until the steering operation is reflected in the behavior of the vehicle.

Furthermore, in a case in which the first and second members and the bracket are separated members, these members are subjected to loads individually. Thus, to inhibit deformation of the instrument panel R/F, it is necessary to improve the stiffness of each member. In addition, since the bracket is concentrated with the loads from the first and second members as well as the load from the steering column, the bracket may be easily deformed.

In contrast, in the aforementioned embodiment, the upper top portion 30, the upper first side wall 31, and the upper second side wall 32 of the upper member 3 are respectively joined to the lower top portion 40, the lower first side wall 41, and the lower second side wall 42 of the lower member 4 in an overlapping state. The lower first-member joint portion 41A of the lower first side wall 41 and the lower second-member joint portion 42A of the lower second side wall 42 are respectively joined to the first member 1 and the second member 2. Accordingly, the stiffness of the steering bracket SB is improved.

This makes it possible to inhibit vibration in the steering and the delay until the steering operation is reflected in the behavior of the vehicle. In addition, the weight of the steering bracket SB can be reduced.

Furthermore, since molding of the steering bracket SB can become easily, and the instrument panel R/F 100 can be structured with a pipe having a simple shape, welding operation and the like can be performed easily, which can reduce the development costs and the manufacturing costs of the instrument panel R/F 100. In addition, the steering bracket SB can be easily shared among multiple car models, and the steering bracket SB can be easily used for other car models.
(2) Each of the lower first-member joint portion 41A and the lower second-member joint portion 42A extends over the ranges of 90 degrees or more about the central axis A1 of the first member 1 or about the central axis A2 of the second member 2. This enables the lower first-member joint portion 41A and the lower second-member joint portion 42A to be respectively joined to the first member 1 and the second member 2 more firmly. Accordingly, the stiffness of the instrument panel R/F 100 is improved.
(3) The front first side wall 51 and the front second side wall 52 of the front member 5 of the steering bracket SB are provided with the front column joint portion 55. This makes it possible to suitably support the steering column SC.
(4) The steering bracket SB is provided with the lateral member 6, which is joined to the upper-end joint portion 72 of the floor-to-brace 7. This makes it possible to improve the stiffness of the steering bracket SB.
(5) The front member 5 is joined to the steering column SC through the front column joint portion 55 and to the vehicle body, forward of the steering column SC, through the front body joint portion 53A. In addition, the shape formed by the front member 5 and the front portion of the upper member 3 improves the section modulus. This makes it possible to improve the stiffness against the loads applied to the front end and the rear end of the steering bracket SB and inhibit deformation of the first and second members 1 and 2.

### 8. Other Embodiments

(1) In the aforementioned embodiment, the lower first-member joint portion 41A and the lower second-member joint portion 42A, which are respectively joined to the first and second members 1 and 2, and the rear column joint portion 30C are provided in the portions formed by overlapping the two plate-shaped portions of the steering bracket SB. However, each of the portions where these joint portions are provided may be formed by overlapping three or more plate-shaped portions.
(2) Two or more functions of a single element in the above-described embodiments may be performed by two or more elements, and a single function of a single element may be performed by two or more elements. Two or more functions performed by two or more elements may be performed by a single element, and a single function performed by two or more elements may be performed by a single element. Part of the configuration in the above-described embodiments may be omitted. At least a part of the configuration in the above-described embodiments may be added to or replace another configuration in the above-described embodiments.

### 9. Technical Ideas Disclosed Herein

### [Item 1]

An instrument panel reinforcement configured to be mounted in a vehicle and support a steering column, the instrument panel reinforcement comprising:
a first member that is arranged on a driver side of the vehicle and that extends in vehicle-width directions;
a second member that is arranged on a passenger side of the vehicle and that extends in the vehicle-width directions; and
a steering bracket that is located between the first member and the second member and that includes an upper member and a lower member, wherein
the upper member includes:
   an upper top portion that is a plate-shaped portion, and
   an upper first side wall and an upper second side wall that are plate-shaped portions protruding downward from the upper top portion and facing each other in the vehicle-width directions,
the lower member includes:
   a lower top portion that is a plate-shaped portion arranged such that the upper top portion is overlaps the lower top portion from above and joined to the upper top portion,
   a lower first side wall and a lower second side wall that are plate-shaped portion protruding downward from the lower top portion and facing each other in the vehicle-width directions,
   a lower first-member joint portion provided on the lower first side wall and configured to be joined to an outer-circumferential surface of the first member, and
   a lower second-member joint portion is provided on the lower second side wall and configured to be joined to an outer-circumferential surface of the second member,
the upper top portion and the lower top portion are provided with a rear column joint portion configured to join the steering column thereto,
the lower first side wall is arranged such that the upper first side wall overlaps the lower first side wall from the driver side and joined to the upper first side wall, the lower second side wall is arranged such that the upper second side wall overlaps the lower second side wall from the passenger side and joined to the upper second side wall.

### [Item 2]

The instrument panel reinforcement according to Item 1, wherein
the lower first-member joint portion is formed to extend, along the outer-circumferential surface of the first member, over a range of 90 degrees or more in a circumferential direction about a central axis of the first member, and
the lower second-member joint portion is formed to extend, along the outer-circumferential surface of the second member, over a range of 90 degrees or more in a circumferential direction about a central axis of the second member.

### [Item 3]

The instrument panel reinforcement according to Item 1 or 2,
the steering bracket further includes a front member located below the upper member and forward of the lower member,
the front member includes:
   a front bottom portion that is a plate-shaped portion,
   a front body joint portion configured to be joined, forward of the first and second members, to a vehicle body, and
   a front first side wall and a front second side wall that are plate-shaped portions protruding upward from the front bottom portion and facing each other in the vehicle-width directions, and
the front first side wall and the front second side wall are provided with a front column joint portion configured to join the steering column thereto.

### [Item 4]

The instrument panel reinforcement according to any one of Items 1 to 3, further comprising
a third member that is an elongated member configured to be joined, below the instrument panel reinforcement, to a vehicle body, wherein
the steering bracket further includes a lateral member joined to the lower second side wall and to an outer-circumferential surface of the second member, and
an end of the third member is joined to the lateral member.

What is claimed is:

1. An instrument panel reinforcement configured to be mounted in a vehicle and support a steering column, the instrument panel reinforcement comprising:
a first member that is arranged on a driver side of the vehicle and that extends in vehicle-width directions;
a second member that is arranged on a passenger side of the vehicle and that extends in the vehicle-width directions; and
a steering bracket that is located between the first member and the second member and that includes an upper member and a lower member, wherein the upper member includes:
an upper top portion that is a plate-shaped portion, and
an upper first side wall and an upper second side wall that are plate-shaped portions protruding downward from the upper top portion and facing each other in the vehicle-width directions,
the lower member includes:
a lower top portion that is a plate-shaped portion arranged such that the upper top portion overlaps the lower top portion from above and joined to the upper top portion and,
a lower first side wall and a lower second side wall that are plate-shaped portions protruding downward from the lower top portion and facing each other in the vehicle-width directions,
a lower first-member joint portion provided on the lower first side wall and configured to be joined to an outer-circumferential surface of the first member, and
a lower second-member joint portion provided on the lower second side wall and configured to be joined to an outer-circumferential surface of the second member,
the upper top portion and the lower top portion are provided with a rear column joint portion configured to join the steering column thereto,
the lower first side wall is arranged such that the upper first side wall overlaps the lower first side wall from the driver side and joined to the upper first side wall, and
the lower second side wall is arranged such that the upper second side wall overlaps the lower second side wall from the passenger side and joined to the upper second side wall.

2. The instrument panel reinforcement according to claim 1, wherein
the rear column joint portion is configured as at least one bolt hole passing through the upper top portion and the lower top portion.

3. The instrument panel reinforcement according to claim 1, wherein
the lower first-member joint portion is formed to extend, along the outer-circumferential surface of the first member, over a range of 90 degrees or more in a circumferential direction about a central axis of the first member, and
the lower second-member joint portion is formed to extend, along the outer-circumferential surface of the second member, over a range of 90 degrees or more in a circumferential direction about a central axis of the second member.

4. The instrument panel reinforcement according to claim 1, wherein
the steering bracket further includes a front member located below the upper member and forward of the lower member,
the front member includes:
a front bottom portion that is a plate-shaped portion,
a front body joint portion configured to be joined, forward of the first and second members, to a vehicle body, and
a front first side wall and a front second side wall that are plate-shaped portions protruding upward from the front bottom portion and facing each other in the vehicle-width directions, and
the front first side wall and the front second side wall are provided with a front column joint portion configured to join the steering column thereto.

5. The instrument panel reinforcement according to claim 4, wherein
the upper top portion includes a first portion located above the lower top portion and a second portion located above the front member, and
the second portion is an elongated portion extending forward from the first portion, a length of the second portion in the vehicle-width directions being shorter than that of the first portion.

6. The instrument panel reinforcement according to claim 4, wherein
a space is provided between the front member and the lower member, and
the front column joint portion is configured as two bolt holes each provided near rear ends of the front first side wall and the front second side wall.

7. The instrument panel reinforcement according to claim 1, further comprising
a third member that is an elongated member configured to be joined, below the instrument panel reinforcement, to a vehicle body, wherein the steering bracket further includes a lateral member joined to the lower second side wall and to the outer-circumferential surface of the second member, and
an end of the third member is joined to the lateral member.

8. The instrument panel reinforcement according to claim 7, wherein
the lateral member includes a floor-to-brace joint portion and a bracket joint portion, the floor-to-brace joint portion being joined to the end of the third member, the bracket joint portion being joined to the upper member, and
the floor-to-brace joint portion includes:
a main surface portion arranged so as to face the second member with a space therebetween and joined to the end of the third member,
a first side wall protruding toward the second member from an edge of the main surface portion, and
an outer-circumferential surface joint portion provided at an edge portion of the first side wall and joined to the second member.

9. The instrument panel reinforcement according to claim 7, wherein
the third member includes a body that is a tubular portion and an upper-end joint portion provided at an upper end of the body, and
the upper-end joint portion includes:
a base that is an elongated plate-shaped portion, the base being joined to the lateral member, and
a second side wall that is a wall-shaped portion protruding from an edge of the base toward a side opposite where the lateral member is located.
